(19) United States
(12) Patent Application Publication
(10) Pub. No.: US 2010/0055538 A1
(43) Pub. Date: Mar. 4, 2010

(54) FUEL CELL FLOW FIELD HAVING METAL BIPOLAR PLATES

(76) Inventors: Weilong Zhang, Glastonbury, CT (US); Patrick L. Hagans, Columbia, CT (US); Nikunj Gupta, Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/514,623

(22) PCT Filed: Dec. 8, 2006
(86) PCT No.: PCT/US06/46839

§ 371 Date: May 13, 2009

(51) Int. Cl. H01M 8/02

(52) U.S. Cl. 429/34; 427/115; 429/210

(57) ABSTRACT

A bipolar plate (30, 30′) for use in a fuel cell (12, 14) includes a first metal layer (40a) having a first corrosion potential and a second metal layer (40b) that tends to grow an oxide layer (42, 42′) during operation of the fuel cell (12, 14). The second metal layer (40b) includes a second corrosion potential such that there is a corrosion potential gradient between the first metal layer (40a) and the second metal layer (40b) that resists growth of the oxide layer (42, 42′).

### FIELD OF THE DISCLOSURE

This disclosure generally relates to fuel cells and, more particularly, to flow field plates for fuel cells.

### DESCRIPTION OF THE RELATED ART

Fuel cells are widely known and used for generating electricity in a variety of applications. Typically, a fuel cell unit includes an anode electrode, a cathode electrode, and an ion-conducting polymer exchange membrane (PEM) between the anode electrode and the cathode electrode for generating electricity from a known electrochemical reaction. Several fuel cell units are typically stacked together to provide a desired amount of electrical output. Typically, a bipolar plate is used to separate adjacent fuel cell units. In many fuel cell stack designs, the bipolar plate functions as a flow field to deliver reactant gases, remove waste heat, and to conduct electrons within an internal circuit as part of the electrochemical reaction to generate the electricity.

Presently, the bipolar plates are made of graphite to provide a desired level of electrical conductivity. The graphite is also resistant to corrosion within the relatively harsh environment of the fuel cell. However, a significant drawback of using graphite is that the plate must be relatively thick to achieve a desired strength, thereby reducing power density of the fuel cell stack. Alternatively, the bipolar plates are made of a metal. However, many commonly used metals corrode in the fuel cell environment, thereby producing an electrically insulating layer that undesirably increases an electrical contact resistance between the bipolar plate and the electrodes and may poison the electrodes to limit the lifetime of the fuel cell. Therefore, a relatively thin bipolar plate that resists corrosion is needed to increase the volumetric power density and reduce the expense of a fuel cell stack.

### SUMMARY OF THE DISCLOSURE

One example bipolar plate for use in a fuel cell includes a first metal layer having a first corrosion potential and a second metal layer having a tendency to grow an electrically passive layer during operation of the fuel cell. The second metal layer includes a second, different corrosion potential such that there is a corrosion potential gradient, or difference, between the first metal layer and the second metal layer that is operative to control growth of the electrically passive layer.

An example method for use with a fuel cell includes the steps of forming a bipolar plate using a metal layer having a tendency to grow an electrically passive layer and establishing a corrosion potential gradient for controlling a nominal growth rate of any electrically passive layer growing at the metal layer.

In another aspect, a fuel cell assembly includes a cell stack having one or more electrodes and one or more bipolar plates associated with the electrodes. Each of the bipolar plates includes a first metal layer having a first corrosion potential and a second metal layer having a tendency to grow an electrically passive layer during operation of the fuel cell. The second metal layer includes a second, different corrosion potential such that there is a corrosion potential gradient between the first metal layer and the second metal layer that is operative to control growth of any electrically passive layer at the second metal layer.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates selected portions of an example fuel cell stack.

FIG. 2 illustrates an example bipolar plate according to the section line shown in FIG. 1.

FIG. 3 illustrates an example bipolar plate having a metal layer mesh.

FIG. 4 illustrates an example bipolar plate having a third metal layer.

### DETAILED DESCRIPTION OF THE PREFERRED EMBODIMENTS

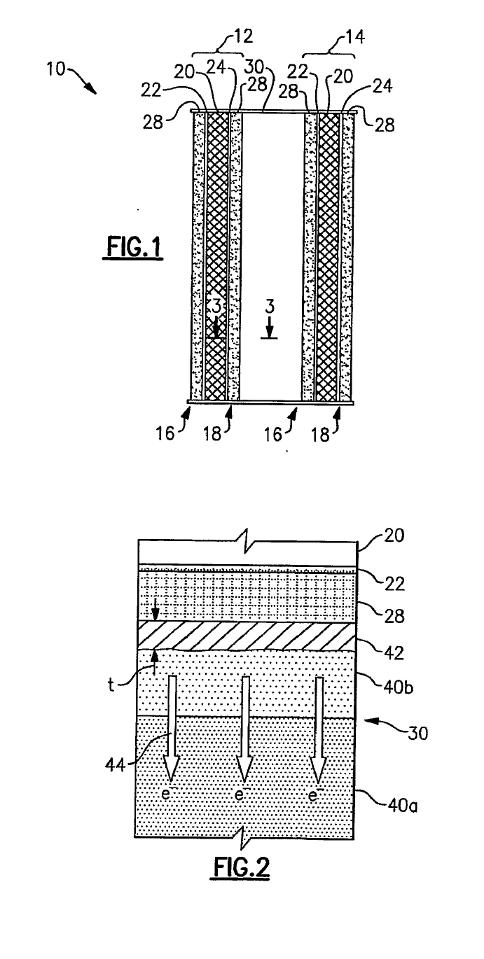

FIG. 1 schematically illustrates selected portions of an example fuel cell stack 10 for generating electricity. In this simplified example, the fuel cell stack 10 includes fuel cells 12 and 14 that each has a cathode 16 that receives a first reactant gas and an anode 18 that receives a second reactant gas to generate an electric current using a known reaction. Each fuel cell 12 and 14 includes a polymer exchange membrane (PEM) 20 that separates a cathode catalyst 22 from an anode catalyst 24. Gas diffusion layers 28 distribute the reactant gases over the respective cathode catalyst 22 and anode catalyst 24 in a known manner, and a metal bipolar plate 30 separates the fuel cells 12 and 14.

FIG. 2 schematically illustrates the portion of the example fuel cell 12 according to the section shown in FIG. 1. In this example, the metal bipolar plate 30 includes a first metal layer 40a galvanically coupled with a second metal layer 40b. In one example, the metal layers 40a and 40b are in direct contact with each other such that the contact prevents significant amounts of water and/or reactant gas from coming between the metal layers 40a and 40b at the contact point (region/area). Furthermore, the metal layers 40a and 40b are exposed to the same reactant gas environment in the fuel cell stack 10 during operation that produces a galvanic current between the metal layers 40a and 40b. In one example, the metal layers 40a and 40b are metallurgically bonded using welding, diffusion bonding, high compression force, etc. or other method for achieving intimate contact.

The first metal layer 40a has a first corrosion potential and the second metal layer 40b has a second, different corrosion potential such that there is a corrosion potential gradient between the first metal layer 40a and the second metal layer 40b. In one example, corrosion potential is determined from a known galvanic series or from corrosion potential evaluations in a simulated fuel cell environment.

In operation, the electrochemical reactions within the fuel cells 12 and 14 produce a relatively harsh environment for the metal bipolar plate 30. For example, the cathode 16 produces an acidic, oxidizing environment and the anode 18 produces an acidic, reducing environment. In the disclosed example, the harsh environment at the cathode tends to grow an oxide layer 42 at the metal bipolar plate 30. In one example, the oxide layer 42 is a metal oxide of a metal used in the metal bipolar plate 30, such as chromium oxide or iron oxide or mixtures thereof. The oxide layer 42 is generally a poor electrical conductor and increases electrical contact resistance of the metal bipolar plate 30 (i.e., the ability of the metal bipolar plate 30 to conduct electrons from the cathode 16 or the anode 18). Thus, in this example the oxide layer 42 is passive and protects the underlying second metal layer 40b from corrosion.

In the disclosed example, the first metal layer 40a and the second metal layer 40b cooperate to resist growth of the electrically passive layer 42 to maintain a desired thickness of the oxide layer 42. Resisting growth provides the benefit of maintaining a desirable level of electrical contact resistance of the metal bipolar plate 30.

In the illustrated example, the second metal layer 40b has a more negative corrosion potential than the first metal layer 40a (i.e., the first metal layer 40a is more noble). The difference in corrosion potential (i.e., the corrosion potential gradient) produces a corrosion current 44 of electrons from the second metal layer 40b to the first metal layer 40a. In this example, the flow 44 results in dissolution of the oxide layer 42 to maintain or reduce a thickness (t) of the oxide layer 42. In some examples, the thickness (t) is maintained at a desired thickness (t) suitable to protect the underlying layer 40b from corroding. Alternatively, the first metal layer 40a is more negative than the second metal layer 40b. It is believed that this would induce oxygen reduction reactions that control the thickness (t) of the oxide layer 42.

In one example, the oxide layer 42 is a metal oxide of a metal of the second metal layer 40b. The flow 44 of electrons reduces the metal oxide, resulting in a thinner passive film of the passive layer. The thinner passive film provides the benefit of better electrical conductivity. Maintaining the desirable thickness (t), in turn provides enhanced, that is reduced, long term electrical contact resistance of the metal bipolar plate 30.

In another example, the second corrosion potential is about 200 mV different than the first corrosion potential. In one example, the difference is about 150 mV. In another example, the second corrosion potential is between about 30 mV and about 50 mV less than the first corrosion potential (i.e., more negative). Such a difference provides the benefit of a flow 44 of electrons that provides a desirable rate of dissolution of the oxide layer 42 without significant dissolution of the base metal of the second metal layer 40b or poisoning of the fuel cell catalyst 22, 24. Differences in corrosion potential that are above 200 mV may result in a relatively large galvanic current that may result in dissolution of the base metal into the gas diffusion layer 28, where the metal can contact and poison the fuel cell catalyst 22, 24. However, if the difference is below 30 mV, the rate of dissolution may not be enough to significantly control or reduce the size of the oxide layer 42. Given this description, one of ordinary skill in the art will recognize suitable differences in corrosion potential to meet the needs of their particular design.

In some examples, the corrosion potential gradient functions to control the growth rate of the oxide layer 42 as described above such that the thickness (t) does not exceed a predetermined threshold thickness. In some examples, the corrosion potential gradient functions primarily when the fuel cell stack 10 is inactive (e.g., when reactant gas supply is shut off) to reduce the thickness (t) of the oxide layer 42 during fuel cell inactivity.

In the disclosed example, the first metal layer 40a is made of a first type of metal (or metal alloy) and the second metal layer 40b is made of a second, different type of metal (or metal alloy). In one example, the first type of metal is a stainless steel and the second type of metal is a nickel alloy or nickel-chromium alloy, which provide a desirable corrosion potential gradient for some situations.

In one example, the first metal layer 40a has a nominal composition of about 50 wt % to 70 wt % of Fe, about 9 wt % to 26 wt % of Ni, about 12 wt % to 25 wt % of Cr, about 2 wt % to 4 wt % of Mo, and about 1 wt % to 2 wt % of Mn. In some examples, the composition includes less than 3 wt % of other common impurity elements, such as P, S, Si, and C. In a further example, the amount of Fe is about 60 wt % to 65 wt %, the amount of Ni is about 10 wt % to 14 wt %, and the amount of Cr is about 16 wt % to 18 wt %.

In this example, the second metal layer 40b has a nominal composition of about 55 wt % to 75 wt % Ni, about 15 wt % to 23 wt % Cr, about 2 wt % to 25% of Mo, about 10 wt % to 14 wt % W, about 2 wt % to 5 wt % of Fe, and about 0.5 wt % to 1 wt % of Mn. In some examples, the composition includes less than 1 wt % of other elements, such as Al, B, La, Si, and C.

The above nominal compositions provide the benefit of a desirable corrosion potential gradient between the first metal layer 40a and the second metal layer 40b. The term “about” as used in this description relative to the compositions refers to possible variation in the compositional percentages, such as normally accepted variations or tolerances in the art.

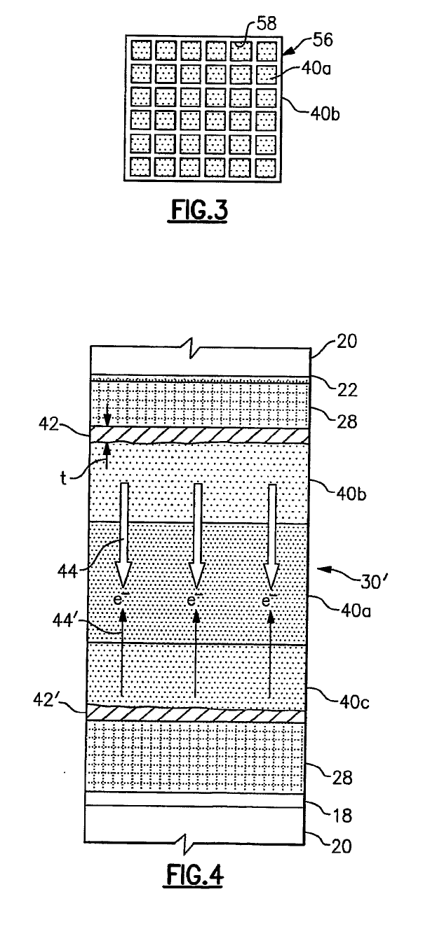

In this example, at least one of the layers 40a or 40b is non-continuous. FIG. 3 illustrates an example in which the second metal layer 40b comprises a mesh 56 having openings 58. The mesh 56 provides the benefit of permitting control over a ratio of exposed surface area of the first metal layer 40a and the second metal layer 40b. For example, providing smaller openings 58 decreases the exposed area of the first metal layer 40a. In contrast, providing larger openings 58 increases the exposed area of the first metal layer 40a. The mesh 56 can be selected to achieve a desired ratio of exposed surfaces areas which corresponds to the galvanic current supported by each layer and the ability to control the thickness (t) of the oxide layer 42.

Controlling or selecting the ratio of exposed surface area provides the benefit of controlling the galvanic current within the metal bipolar plate 30 to thereby control the rate of dissolution, or in some circumstances the growth rate, of the oxide layer 42. In one example, the contact area is used in combination with known corrosion potentials of the first metal layer 40a and the second metal layer 40b to produce a desirable dissolution rate of the oxide layer 42. Given this description, one of ordinary skill in the art will recognize alternative non-continuous patterns to meet their particular needs.

FIG. 4 illustrates a typical complete cell version of a metal bipolar plate 30′. In this example, the metal bipolar plate 30′ is substantially similar to the metal bipolar plate 30 shown in FIG. 2, except that the metal bipolar plate 30′ includes a third metal layer 40c galvanically coupled to the first metal layer 40a. In this example, the first metal layer 40a is between the second metal layer 40b and the third metal layer 40c.

The example third metal layer 40c has a nominal composition that is equal to the nominal composition of the second metal layer 40b, such as a composition described above. As with the second metal layer 40b (in this example considered the cathode environment), the third metal layer 40c includes a corrosion potential that is established by the reactant gas environment on that side of the cell, typically the anode gas environment. Thus, the third metal layer 40c functions in a similar manner as the second metal layer 40b.

The disclosed example metal bipolar plates provide the benefit of improved volumetric power density compared to previously known graphite bipolar plates. The example metal bipolar plates resist growth of the oxide layer 42, 42′ to thereby allow the use of metallic materials in the relatively harsh environment of a fuel cell stack without significant penalty to conductivity. Moreover, the high strength of metallic materials compared to graphite allows the example bipolar plates to be relatively thinner compared to graphite plates. Thinner bipolar plates reduce the cell stack assembly size and provide more power per volume of a fuel cell stack.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

We claim:

1. An article for use in a fuel cell, comprising:
a bipolar plate having a first metal layer having a first corrosion potential; and
a second metal layer galvanically coupled with the first metal layer and having an oxide layer during operation of the fuel cell, the second metal layer having a second, different corrosion potential such that there is a corrosion potential gradient between the first metal layer and the second metal layer that is operative to control growth of the oxide layer at the second metal layer.

2. The article as recited in claim 1, wherein the second corrosion potential is between about 200 mV different relative to the first corrosion potential.

3. The article as recited in claim 2, wherein the second corrosion potential is between about 30 mV and about 50 mV different relative to the first corrosion potential.

4. The article as recited in claim 1, wherein the oxide layer has an associated growth rate, and wherein the corrosion potential gradient reduces the growth rate.

5. The article as recited in claim 1, wherein the first metal layer includes a stainless steel and the second metal layer includes at least one of a nickel-based alloy or a nickel-chromium based alloy.

6. The article as recited in claim 5, wherein:
the first metal layer includes a nominal composition of between about 50 wt % to 70 wt % of Fe, about 9 wt % to 26 wt % of Ni, about 12 wt % to 25 wt % of Cr, about 2 wt % to 4 wt % of Mo, and about 1 wt % to 2 wt % of Mn; and
the second metal layer includes a nominal composition of about 55 wt % to 75 wt % Ni, about 15 wt % to 23 wt % Cr, about 2 wt % to 25% of Mo, about 10 wt % to 14 wt % W, about 2 wt % to 5 wt % of Fe, and about 0.5 wt % to 1 wt % of Mn.

7. The article as recited in claim 6, including a third metal layer having a nominal composition equal to the nominal composition of the second metal layer, wherein the first metal layer is between the second metal layer and the third metal layer.

8. The article as recited in claim 1, wherein the first metal layer includes a solid, continuous planar section and the second metal layer includes a non-continuous section directly adjacent the solid, continuous planar section.

9. The article as recited in claim 1, wherein the non-continuous section comprises a mesh.

10. The article as recited in claim 6, wherein the amount of Fe is about 60 wt % to 65 wt %, the amount of Ni is about 10 wt % to 14 wt %, and the amount of Cr is about 16 wt % to 18 wt % in the nominal composition of the first metal layer.

11. The article as recited in claim 1, wherein corrosion potential gradient is operative to prevent a thickness of the oxide layer from exceeding a threshold.

12. The article as recited in claim 1, wherein the corrosion potential gradient is operative to reduce a thickness of the oxide layer.

13. The article as recited in claim 1, wherein the corrosion potential gradient is operative to prevent an electrical contact resistance from exceeding a threshold.

14. A method for use with a fuel cell, comprising:
(a) forming a bipolar plate using a metal layer having a potential to grow an oxide layer; and
(b) establishing a corrosion potential gradient for controlling a nominal growth rate of the oxide layer growing at the metal layer.

15. The method as recited in claim 14, including galvanically coupling another metal layer of the bipolar plate to the metal layer of the bipolar plate.

16. The method as recited in claim 15, including controlling the nominal growth rate to maintain a selected conductivity of the oxide layer.

17. The method as recited in claim 16, including galvanically dissolving the metal within the oxide layer to reduce the growth rate.

18. The method as recited in claim 15, including controlling a rate of galvanic dissolution by selecting a desired ratio of exposed surface area between the metal layer and the another metal layer.

19. The method as recited in claim 14, including permitting growth of the oxide layer while operating the fuel cell to generate an electric current, and galvanically dissolving the oxide layer when the fuel cell is not operating to generate an electric current.

20. A fuel cell assembly comprising:
a cell stack having a plurality of electrodes; and
a plurality of bipolar plates associated with corresponding electrodes, each of the bipolar plates comprising:
a first metal layer having a first corrosion potential; and
a second metal layer galvanically coupled with the first metal layer and having a potential to grow an oxide layer during operation of the fuel cell, the second metal layer having a second, different corrosion potential such that there is a corrosion potential gradient between the first metal layer and the second metal layer that is operative to control growth of the oxide layer at the second metal layer.

21. The assembly as recited in claim 20, wherein the first metal layer and the second metal layer are in direct contact.
